(19) United States
(12) Patent Application Publication
(10) Pub. No.: US 2014/0013142 A1
(43) Pub. Date: Jan. 9, 2014

(54) PROCESSING UNIT POWER MANAGEMENT

(71) Applicant: Samsung Electronics Co., Ltd., Gyeonggi-do (KR)

(72) Inventor: Srinivas KALAGA, Middlesex (GB)

(21) Appl. No.: 13/935,615

(22) Filed: Jul. 5, 2013

(30) Foreign Application Priority Data
Jul. 6, 2012 (GB) 1212095.2

(51) Int. Cl. G06F 1/32

(52) U.S. Cl. CPC G06F 1/3234
USPC 713/323

(57) ABSTRACT

Methods, apparatus and computer program products for power management of a processing unit. The processing unit can operate in a plurality of operating modes and provides information indicative of memory access miss events. Information indicative of memory access miss events is received, and based at least on the received information, a desired operating mode for the processing unit is determined. The processing unit is then caused to operate in of the desired operating mode based on the determining.

### CLAIM OF PRIORITY

This application claims priority under 35 U.S.C. §119(a) to an Application filed in the Great Britain Intellectual Property Office on Jul. 6, 2012 and assigned Serial No. GB 1212095.2, the entire disclosure of which is incorporated herein by reference.

The present invention relates to systems and methods for power management of a processing unit.

### BACKGROUND

Many processing units, such as central processing units (CPUs), are capable of operating at different power or performance levels. At high power levels, the performance of the CPU is increased, however the power consumed by the CPU also increases. Conversely, at low power levels the power consumed by the CPU decreases, however the performance also decreases.

In many applications, in particular where the CPU is provided in a mobile device such as a smartphone, PDA, tablet computer or laptop, it is important to achieve the right balance between performance and power consumption. Effective power management, i.e. achieving the right balance, can prolong the battery life of the device while maintaining adequate performance. The power consumed by a CPU may be varied by altering the operating voltage and/or operating frequency of the CPU.

A known method of power management for a CPU in the prior art is to periodically sample the software load by reading the process queue length of the operating system running on the CPU. The queue length is a measure of the number of processes that are waiting to be executed by the CPU. In such known methods, when the queue length is high, the CPU power is increased, and conversely when the queue length is low, the CPU power is decreased.

It is an object of the present invention to provide an improved method of power management for a processing unit.

### SUMMARY

In accordance with at least one embodiment of the invention, methods, devices, systems and software are provided for supporting or implementing functionality to provide power management for a processing unit.

According to a first aspect of the invention there is provided a method of power management for a processing unit, the processing unit configured to operate in a plurality of operating modes and further configured to provide information indicative of memory access miss events, the method comprising: receiving said information indicative of memory access miss events; determining a desired operating mode for the processing unit based at least on the received information; and causing the processing unit to operate in the desired operating mode.

In the course of processing instructions, such as threads, certain instructions or data required by the processing unit are not stored in the lowest level cache memory. Therefore, these instructions or data would have to be retrieved from another source, such as RAM or disk storage, before the processing unit can process the instruction. While the retrieval is taking place, the processing unit idles. These events are called memory access miss events and they are indicative of the workload of the processor. Generally speaking, a relative high number of memory access miss events indicates a heavier workload of the processor,

By using miss events, it is possible to achieve more accurate and finer grained method of controlling the operating mode of a processing unit than other known methods, such as using a measure of the length of the instructions queue (i.e. the number of outstanding instructions which are to be processed by the processing unit).

There are different types of memory access miss events. Thus, the information indicative of memory access miss events may comprise a plurality of values, each representing a count for a different memory access miss events. As such, the method of power management in accordance with the invention may comprise calculating the first value based on a weighted average of the plurality of values. Many processing units provide information indicative of memory access miss events in the form of a counter for a given miss event, which may provide a count for an event in a given period. For example, a processing unit may provide a counter for the number of a certain type of memory access miss event in a period of 100 ms (or between 1 and 100 ms). Calculating a weighted average of these counters therefore provides an efficient method of determining a mode for the processing unit.

In some embodiments, the processing unit may comprise a plurality of cores and may be configured to provide information indicative of memory access miss events for each of the cores. In such embodiments, the method may comprise: determining, for each of the cores, the desired operating mode based on respective first values; and causing the processing unit to operate in the desired operating mode. In a multicore processing unit, first values, which may be the weighted average of counters of memory access miss events, may be calculated for each core independently. The processing unit may be configured such that the operating mode of each of the cores is the same. Therefore out of the first values associated with each core, one is selected to determine the operating mode for the processing unit as a whole. The selected one of the first values may be associated with the processing unit operating a mode providing the highest processing throughput, and therefore the processing unit will provide sufficient performance for all concurrent tasks required of it.

In addition, the processing unit may be configured to provide further information indicative of memory access miss events for a memory shared between at least two of the cores, and the method may comprise: determining a second value based on said further information; and causing the processing unit to operate in the desired operating mode based on a combination of the selected one of the first values and the second value.

In some embodiments, the processing unit may have a shared memory. Therefore a second value may be calculated, in addition to the first, based on events associated with this shared memory. The operating mode may then be determined based on the first values and the second value. This may comprise calculating a sum, average or weighted average of the values. As with a multicore processing unit, the selected one of the first values may be associated with the processing unit operating a mode providing the highest processing throughput.

Each of the plurality of modes may be associated with different power consumption and/or processing throughput of the processing unit. Furthermore, each of the plurality of modes may be associated with a different operating frequency and/or operating voltage for the processing unit.

The information indicative of memory access miss events comprises information indicative of level 1 memory access miss events. These events can include: level 1 instruction cache misses; level 1 data cache misses; and level 1 translation lookaside buffer misses.

The information indicative of memory access miss events may comprise information indicative of level 2 memory access miss events. These events can include: level 2 unified cache misses; and main translation lookaside buffer misses.

The operating mode may be selected to be a relatively high power operating mode when the number of cache misses is relatively high, and the operating mode is selected to be a relatively low power operating mode when the number of cache misses is relatively low.

The processing unit may further be configured to provide information indicative of instructions executed by the processing unit, and the method may further comprise: receiving said information indicative of instructions executed by the processing unit; and determining the desired operating mode based on both the received information indicative of memory access miss events and the received information indicative of instructions executed by the processing unit.

According to a second aspect of the invention there is provided an apparatus for power management of a processing unit, the processing unit configured to operate in a plurality of operating modes and further configured to provide information indicative of memory access miss events, the apparatus comprising: an interface configured to receive said information indicative of memory access miss events; and a processor configured to determine a desired operating mode for the processing unit based at least on the received information, wherein the apparatus is configured to cause the processing unit to operate in the desired operating mode based on said determination. The apparatus may comprise the said processing unit.

According to a third aspect of the invention there is provided a non-transitory computer-readable storage medium having computer readable instructions stored thereon, the computer readable instructions being executable by a computerized device to cause the computerized device to perform a method for power management for a processing unit, the processing unit configured to operate in a plurality of operating modes and further configured to provide information indicative of memory access miss events, the method comprising: receiving said information indicative of memory access miss events; determining a desired operating mode for the processing unit based at least on the received information; and causing the processing unit to operate in the desired operating mode based on said determination.

Further features and advantages of the invention will become apparent from the following description of preferred embodiments of the invention, given by way of example only, which is made with reference to the accompanying drawings.

### BRIEF DESCRIPTION OF THE DRAWINGS

A processing unit will now be described as an embodiment of the present invention, by way of example only, with reference to the accompanying figures in which:

FIG. 1 is a schematic view of the processing unit of the current invention; and

FIG. 2 is a flowchart depicting a method according to an embodiment of the invention.

Several parts and components of the invention appear in more than one figure; for the sake of clarity the same reference numeral will be used to refer to the same part and component in all of the Figures.

### DETAILED DESCRIPTION

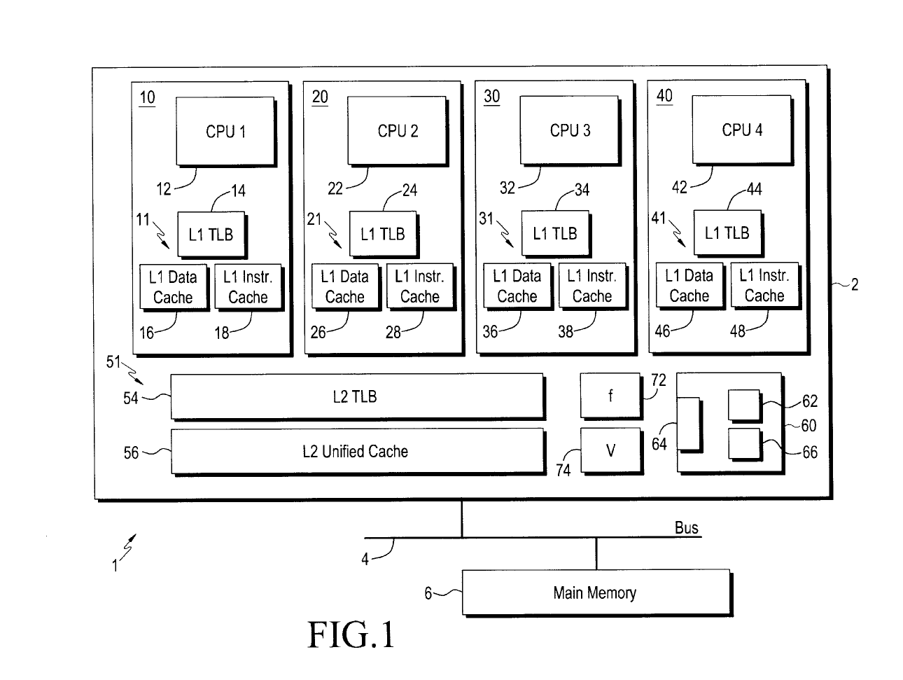

A processing unit, in which embodiments of the invention may be used, will first be described with reference to FIG. 1.

FIG. 1 is a schematic diagram of selected elements of a processing system 1. Within the system 1 a processing unit 2 is connected to a bus 4, and through the bus 4 to a main memory 6.

Within the processing unit 2, four cores 10, 20, 30 and 40 are provided. The first core 10 comprises a central processing unit (CPU) 12, a level one (L1) translation lookaside buffer 14, a level one data cache 16 and a level one instruction cache 18. Together the level one translation lookaside buffer (TLB) 14, level one data cache 16 and level one instruction cache 18 comprise a level one memory system 11.

In line with the first core 10, the second core comprises a central processing unit 22, and a level one memory system 21 comprising a level one translation lookaside buffer 24, a level one data cache 26 and a level one instruction cache 28; the third core comprises a central processing unit 32, and a level one memory system 31 comprising a level one translation lookaside buffer 34, a level one data cache 36 and a level one instruction cache 38; and the fourth core comprises a central processing unit 42, and a level one memory system 41 comprising a level one translation lookaside buffer 44, a level one data cache 46 and a level one instruction cache 48.

A single level two (L2) memory system 51 is provided and is common to all four cores 10, 20, 30 and 40. The level two memory system comprises a level 2 transition lookaside buffer 54 and a unified (i.e. data and instructions) cache 56.

A power management unit 60 is provided within the processing unit 2. The power management unit 60 comprises an interface 64 for receiving information relating to microarchitectural events from the other circuit elements within the processing unit 2. The nature of this information will be described in more detail below. In addition, the power management unit 60 may comprise a processor 62 and a memory 66 so as to be able to perform the steps that will be described below.

The processing unit 2 may further comprise a clock 72 which provides a signal which determines the operating frequency of the processing unit, and a variable voltage supply 74 which provides the operating voltage to the elements within the processing unit 2.

The power management unit 60 is able to cause the processing unit 2 to operate in one of a number of different modes. As such, there may be an interface between the power management unit 60 and the clock 72 and voltage supply 74 that is configured to provide an appropriate output signal to the clock 72 and voltage supply 74 to control the operating frequency and operating voltage of the processing system.

While not shown, the features described above are interconnected so as to be able to transfer data therebetween. Further known elements may be provided within the processing unit 2, such as a memory controller.

In use, for example, CPU 12 processes data in the L1 data cache 16 using instructions in the L1 instruction cache 18. When retrieving data or instructions, the TLB 14 may be used to translate a virtual address in to a physical address within the relevant memory, to enable fast retrieval of the data or instructions. Collectively, retrieval of data or instructions from the L1 data cache 16, L1 instruction cache 18, and address translation using the TLB 14 will be referred to as memory access from the level one memory system 11.

The L1 memory system 11 is relatively small in size. As a result it is a relatively frequent occurrence for there to be a memory access miss event in accessing information from the level one memory system 11. A miss event is where data is required by the processing unit from the level one memory system 11, but is not available in the level one memory system 11. That is, either the data or instructions are not available in the level one memory system 11, or the appropriate address translation is not stored in the TLB 14. When a miss event occurs the CPU 12 will idle while either the desired data or instructions are retrieved from a higher level memory, i.e. the L2 memory system 51 or the main memory 6, in the case of a data or instruction cache miss event; or while the appropriate address translation is derived, in the case of a TLB miss event.

During the idle, the CPU 12 will stop processing instructions, causing the overall processing throughput of the CPU 12 to drop. It should be noted that while there are known techniques in the prior art, sometimes called multi-threading, to enable the CPU 12 to process other data using other instructions, i.e. a different thread, during an idle, overall processing throughput is still reduced by the idle.

After a level one memory access miss event, data or instructions will have to be retrieved from a higher memory. In the first instance, an attempt will be made to retrieve the desired information from the level two memory system 51. If the information is contained within the level two memory system 51, then this data will be sent to the core 10 and stored in the relevant cache memory 16 or 18, the L1 TLB 14 may also be updated. The level 2 TLB provides address translation to assist this process, in an analogous manner to the L1 TLB 14.

If the desired information is not available from the level 2 memory system 51, or if the L2 TLB 54 is not able to provide the appropriate translation of address, then a level 2 memory access miss event occurs. Again, the CPU will idle, and the relevant information is retrieved from the main memory 6 over the bus 4. The data may then be stored in the L1 and/or L2 memory systems as desired. Either or both of the L1 TLB 14 and the L2 TLB 54 may be updated to reflect the new data.

The level 1 memory system 11, 21, 31, and 41 and the level 2 memory system 51 may collect information on the memory access miss events. This information may be in the form of a count of the number of miss events, or a measure of their relative frequency. In addition, the CPU 12 may collect information on the number of instructions processed. This information may be passed to the power management unit 60, which may receive and process the information in the method described below.

It will be appreciated that while the above has been described in terms of the first core 10, the same processes occur within each core. In addition, as the level 2 memory system 51 is shared, level 2 memory access miss events may be created by an attempt to access data by any of the cores.

Having processed the information on memory access miss events, and optionally the information from the CPUs on the number of instructions processed, the power management unit 60 may cause the operating mode of the processing unit to change. Typically each operating mode will provide a different level of processing throughput, at a different power consumption. As mentioned above, there is typically a trade off between processing throughput and power consumption, therefore at least one mode will represent a low power, low processing throughput configuration, and at least one further mode will represent a high power, high processing throughput configuration. Typically there will be many other modes for finer granularity and control, distributed between the high and low extremes.

One method of configuring the processing unit 2 to operate in different modes according to embodiments will now be described. In these embodiments the processing unit is able to operate at a number of different voltages (V) and operating frequencies (f).

The power consumed in the processing unit will be proportional to the frequency f multiplied by the square of the voltage V. The processing throughput of the processing unit will typically depend on the frequency f. However, at higher frequencies f, a higher voltage V is required to enable the circuit components to switch in time. In other words, the operating voltage V can be decreased when the frequency f is decreased. Because the total power increases as the square of the voltage V, for any given processing throughput, i.e. frequency f, it is desirable to use the lowest voltage V possible while still enabling the processing unit to operate at the desired throughput.

In these embodiments, a series of operating modes may be established, each with a unique combination of voltage and frequency, and each with an associated processing throughput and power consumption. For example, the following operating modes may be used:

| Mode # | Operating Voltage V | Operating Frequency f |
|---|---|---|
| 1 | 1.2 V | 1.2 GHz |
| 2 | 1.0 V | 1.0 GHz |
| 3 | 0.9 V | 0.9 GHz |
| 4 | 0.8 V | 0.5 GHz |

The operating mode may be changed during run time depending on the requirements on the processing unit, so as to achieve a desired balance between processing throughput and power consumption. The above method may be termed dynamic voltage and frequency scaling (DVFS).

The processing unit may work in one of a plurality of discrete modes, however the values used to determine the mode may be variable on a much higher granularity. For example, the values used for the plurality of modes may be stored in a lookup table.

The power management unit 60 may control the operating voltage and operating frequency by sending appropriate signals to the clock 72 and voltage control unit 74 through an appropriate interface.

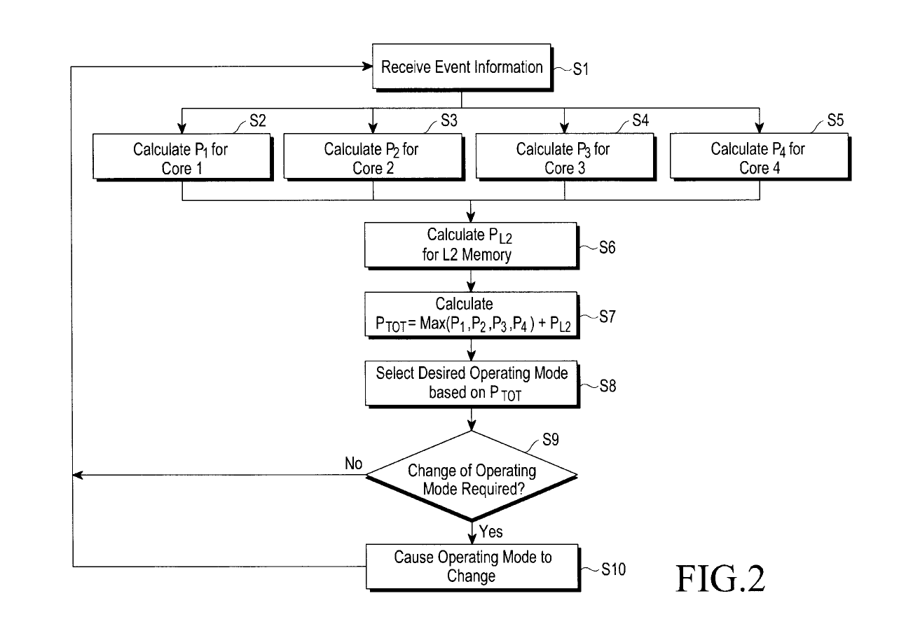

A method by which the power management unit 60 described above may alter the operating mode of the processing unit according to embodiments will now be described with reference to FIG. 2.

In step S1, the power management unit 60 receives event information from the circuit elements within the processing unit 2. Typically this will include level 1 miss event information from the level 1 memory systems 11, 21, 31 and 41; level 2 miss even information from the level 2 memory system 51; and information indicative of the instructions executed by the CPUs 12, 22, 32 and 42 within the cores. This information may be received via the interface 64.

As shown above, the processing unit 2 has multiple cores, and therefore different information may be received for each core. In the description below, a generalized core will be given a suffix N, representing the Nth core. As described above, the event information received may comprise the following values:
instructions executed (I1_{N} for N=1 to 4);
level 1 instruction cache misses (IC1_{N} for N=1 to 4);
level 1 data cache misses (DC1_{N} for N=1 to 4);
level 1 TLB misses (TM1_{N} for N=1 to 4);
level 2 (unified) cache misses (C2); and
level 2 (main) TLB misses (TM2).

Each of the values may be representative of a count for a given period of time (i.e. a frequency) for the associated event. The given period of time may be predetermined, and for example may be selected based on the frequency at which the processing unit 2 is operating. Typically the period of time will be between 1 and 100 ms. However, this given period of time may be adjusted and updated depending on the operating frequency of the processing unit 2 during runtime.

In steps S2, S3, S4 and S5, the processor 62 of the power management unit 60 calculates a first value PN for each core based on the received information. PN may thus be calculated as a weighted average of this received information according to the formula:

P_{N}=α₁·I1_{N}+α₂·IC1_{N}+α₃·DC1_{N}+α₄·TM1_{N}

Having calculated P₁, P₂, P₃ and P₄ for cores 1, 2, 3 and 4 respectively, in step S6 the processor 62 of the power management unit 60 may calculate a second value based on the received information. The second value is denoted as P_{L2}. P_{L2} may be calculated according to the following formula:

P_{L2}=α₅·C2+α₆·TM2

The above equations use the weights α₁, α₂, α₃, α₄, α₅, and α₆. These weights may be previously determined based on the specifications of the processing unit. The weighting given to values associated with a level 2 memory access miss event may be higher than the weighting given to values associated with a level 1 memory access miss event. This is because level 2 memory access requires greater power than level 1 memory access.

In step S7, the power management unit 60 combines the first and second values to produce a third, overall, value P_{TOT}. In this embodiment, P_{TOT} is calculated using the following formula:

P_{TOT}=Max(P₁, P₂, P₃, P₄)+P_{L2}

Having calculated P_{TOT}, in step S8, the power management unit 60 selects a desired operating mode based on P_{TOT}. In this embodiment, the processing unit 2 may have a plurality of different operating modes, and the appropriate operating mode may be selected using, for example a lookup table.

| Condition | Mode # |
|---|---|
| β₃ ≦ P_{TOT} | 1 |
| β₂ ≦ P_{TOT} < β₃ | 2 |
| β₁ ≦ P_{TOT} < β₂ | 3 |
| P_{TOT} < β₁ | 4 |

where β₁, β₂, β₃ and β₄ are predetermined constants.

Having selected a desired operating mode, in step S9 the power management unit 60 determines if a changed of mode is required based on the desired operating mode, and the current operating mode of the processing unit 2. If a change is required, i.e. if the desired and current operating modes do not match, then in step S10 the power management unit 60 causes the operating mode of the processing unit 2 to change. This may be done by sending a signal to one or more circuit elements within the processing unit, for example a clock unit 72 or a voltage supply unit 74.

If no change in the operating mode is required, then the power management unit 60 repeats steps S1 onwards to determine the operating mode for the processing unit 2 based on newly received information.

While the above embodiments have been described with reference to a multicore processing unit 2, it will be apparent that the above method is applicable to embodiments in which there is only a single core. In such embodiments, separate first and second values may not be calculated, and the third value, P_{TOT} may be directly calculated using an equation such as:

P_{TOT}=α₁·I1+α₂·IC1+α₃·DC1+α₄·TM1+α₅·C2+α₆·TM2

An example of calculations for a real world application will now be described. This example will be described in relation to a user browsing the web on a smartphone or similar portable device. The device has a single core processor. There are a number of stages involved in the browsing process, the stages being either CPU intensive, I/O intensive or a combination of the two. It is assumed that the browser is the only major application requiring a heavy workload from the processing unit. Exemplary stages in the operation of the device while browsing include:
1. Running the HTML/JavaScript interpreter: CPU intensive.
2. Sending or Receiving over network: I/O intensive.
3. Data storage to RAM or non-volatile storage: I/O intensive.
4. Idle, while the user e.g. views the page.
In this example the sampling of the event counters is done at a rate of 100 ms. Each count value is reset for each sampling period. In addition, the count values will be normalized, that is divided, by a factor between 1000 and 100,000, depending on the type of value. The result is rounded down to the nearest whole. In this example, the values used for the calculation of P_{TOT} are as follows:
instructions executed (I1)—up to 800 million events per 100 ms duration, normalized by a factor of 100 thousand giving range up to 8000;
level 1 instruction cache misses (IC1)—up to 6 million events per 100 ms duration, normalized by a factor of 6000 giving a range up to 1000;
level 1 data cache misses (DC1)—up to 1 million events per 100 ms duration, normalized by a factor of 1000 giving a range up to 1000;
level 1 TLB misses (TM1)—up to 2 million events per 100 ms duration, normalized by a factor of 1000 giving a range up to 2000; and
level 2 (unified) cache misses (C2)—up to 1 million events per 100 ms duration, normalized by a factor of 1000 giving a range up to 1000.
The level 2 TLB (TM2) misses are not used in this example. Therefore the equation to be used to calculate P_{TOT} is:

P_{TOT}=α₁·I1+α₂·IC1+α₃·DC1+α₄·TM1+α₅C2

The weights used are as follows:
a₁=0.3
a₂=0.4
a₃=0.4
a₄=0.5
a₅=0.7

In stage 1, the processing unit 2 is interpreting the HTML/JavaScript, a process which is CPU intensive, resulting in the following values:
I1=180,951,779 events, normalized to 1809;
IC1=430,188 events, normalized to 71;
DC1=34,115 events, normalized 34;
TM1=3123 events, normalized 3; and
C2=14748 events, normalized 14.

Using these values, P_{TOT} is calculated as follows:

P_{TOT}=1809*(0.3)+71*(0.4)+34*(0.4)+3*(0.5)+14*(0.7)=596

In stage 2, the processing unit 2 is performing networking operations to retrieve data from a server, this is I/O intensive, resulting in the following values:
I1=25,685,502 events, normalized to 250;
IC1=399,492 events, normalized to 66;
DC1=68762 events, normalized to 68;
TM1=5181 events, normalized to 5; and
C2=31264 events, normalized to 31;

Therefore:

P_{TOT}=250*(0.3)+66*(0.4)+68*(0.4)+5*(0.5)+31*(0.7)=153

Stage 3 involved received data being stored in RAM or non volatile memory such as on a disk or in flash memory, a process which is I/O intensive, resulting in the following values:
I1=62,120,181 events, normalized to 620;
IC1=2,924,859 events, normalized to 190;
DC1=177,803 events, normalized to 177;
TM1=30,833 events, normalized to 30; and
C2=60,444 events, normalized to 60.

Therefore:

P_{TOT}=620*(0.3)+190*(0.4)+177*(0.4)+30*(0.5)+60*(0.7)=376

Stage 4 is where the processing unit 2 is idling, as the user reads the page on the display, resulting in the following values:
I1=2,146,099 events, normalized to 21;
IC1=196,899 events, normalized to 32;
DC1=12,058 events, normalized to 12;
TM1=930 events, normalized to 0; and
C2=4908 events, normalized to 5.

Therefore:

P_{TOT}=21*(0.3)+32*(0.4)+12*(0.4)+0*(0.5)+5*(0.7)=26

The above-calculated values for P_{TOT} may subsequently be used to determine an operating mode for the processing unit. For example the values for β may be selected to provide the following lookup conditions for the mode.

| Condition | Mode # |
|---|---|
| 450 ≦ P_{TOT} | 1 |
| 300 ≦ P_{TOT} < 450 | 2 |
| 150 ≦ P_{TOT} < 300 | 3 |
| P_{TOT} < 150 | 4 |

Therefore, in the stage 1, where the processor intensive interpretation of the HTML/JavaScript is being performed, mode 1 (the highest power mode) may be selected. Similarly, stage 2 results in mode 3 being selected, the stage 3 results in mode 2 and the stage 4, the idle stage, will cause mode 4 corresponding to a low power state to be selected.

In the above embodiments, the maximum of P₁, P₂, P₃ and P₄, is selected as being effectively representative of the four cores. This is done when all four cores operate at the same frequency and voltage, and ensures that all cores provide suitable performance, even if some of the cores are operating at a processing throughput which is higher than required. Nevertheless, in other embodiments, the maximum may not be used. For example, an average, or the second highest value may be taken and used to determine the operating mode. This average may be weighted towards the maximum value. Other methods of combining P₁, P₂, P₃ and P₄, or selecting a single one of P₁, P₂, P₃ and P₄ may be used.

In addition, it will be apparent that while in the above embodiments high values of P represent a requirement for high processing throughput, this may not be the case. Alternative equations, providing alternative measures of desired modes may be used. For instance, a value Q_{N} may be calculated for each core using the equation:

Q_{N}=γ₁/I1_{N}+γ₂/IC1_{N}+γ₃/DC1_{N}+γ₄/TM1_{N}

The values for Q_{N} may subsequently be combined with an equivalent value Q_{L2} in a manner analogous to the above. These two examples are not the only ones. These and other equations may be used to determine the desired operating mode using the received information.

In some embodiments, separate cores in a multicore processing unit may be independently controllable, that is different cores may operate in different operating modes. In such embodiments, the power management unit 60 may treat each core as a separate processing unit as described in the paragraphs above. Such embodiments do not preclude the level 2 memory system 51 being shared.

The steps S2, S3, S4 and S5 may be performed concurrently, as shown in FIG. 2. However, in alternative embodiments the steps may be performed in any desirable order. Similarly, while the step S1 in which the event information is received is shown as a distinct step at the start of the method, it will be apparent to one of ordinary skill in the art that such information may be received by the power management unit 60 on an ongoing basis during run time, with the operating mode being determined at certain intervals based on the latest data. Such intervals may typically be in the range of 1 ms to 100 ms.

In some embodiments, a number of concurrent values may be averaged to determine the operating mode. As such, values P_{N,t} may be calculated for core N at various times, represented by t. From these values an average may be taken, and used to determine the operating mode of the processing unit 2. For example, values P′_{N} may be calculated using the following:

P′_{N}=(P_{N,t}+P_{N,t-1}+P_{N,t-2}+P_{N,t-3}+P_{N,t-4})/5

and from these values, P_{TOT} may be calculated as:

P_{TOT}=Max(P′₁, P′₂, P′₃, P′₄)+P_{L2}

It will be apparent to one of ordinary skill in the art that in this example, P_{L2} is not averaged, however this does not necessarily have to be the case. Indeed, in an alternative embodiment P_{L2} may be averaged using an analogous process. Alternatively, only P_{L2} may be averaged. In some embodiments, a number of samples for P_{TOT} might be averaged. In alternative embodiments, a weighted average may be used, biased towards more current samples. For example, a leaky integrator may be used to maintain a running average for any particular value.

In the above embodiments, the values P_{N}, P_{L2} and P_{TOT} are absolute values. However it will be appreciated by one of ordinary skill in the art that any or all may be represented as, for example, a percentage of a maximum value.

While the power management unit 60 is shown being a part of the processing unit 2, this may not be the case. Instead, the power management unit 60 may be a separate entity in the overall system. Alternatively, all the described elements may be formed as part of a single unit, i.e. a System-on-A-Chip (SoC). In such embodiments, the bus 4 and main memory 6 may be formed within the processing unit 2. In addition, the number of cores within the processing unit 2 may not be 2, and may be any conceivable number, although in the current state of the art typically 1, 2 or 4, and often between 1 and 9.

The predetermined values αᵢ and βᵢ may be determined when the processing unit is fabricated. For instance, the values for the weights αᵢ may be selected based on the size and/or speed of the memory systems 11, 21, 31, 41, 51, and/or the individual components within in them (i.e. individual cache or TLB sizes). The size of the main memory 6, as well as the instruction pipeline width of the CPUs 12, 22, 32 and 42 may also be a factor. Typically the weights for the level 2 memory system values, i.e. α₅, and α₆ will be higher than the weights for the level 1 memory system values, i.e. α₂, α₃ and α₄, which in turn will be higher than the weight for the instructions executed α₁. This is because level 2 memory system miss events have a longer time to resolve compared to level 1 memory system miss events, and thus have a greater effect on the power consumption of the system. One method to calculate the optimum values known in the prior art is to use standard performance metric tools on trial-and-error mechanism and get the best case and worst case values.

Alternatively, or additionally, a number of different values for α and/or β may be used depending on further factors. For instance, a user configurable option in which the user may select between “better performance” and “better battery life” may cause different values for α and β to be used. Equally, the power management unit 60 may detect when a mobile device is connected to a source of power (such as a mains charger), and select values for α and β accordingly.

It will be appreciated by one of skill in the art that in the example above, the event count values were firstly normalized, and then combined using the weighted averages. It will be apparent that the weighting and normalizing steps may be combined or reversed in alternative embodiments.

The power management unit 60 has been described as receiving information, such as count values, from the various elements in the processor. However, in some embodiments the power management unit 60 may measure the microarchitectural events, and store the count in a memory within the power management unit 60. Thus the processor may receive such count values from a memory within the power management unit 60.

The processor 62 of the power management unit 60 may be a programmable processing unit, or alternatively may be preconfigured hardware. Where average values and the like are being calculated, previous values may be stored in the memory 66.

Embodiments of the invention are particularly suited to mobile applications, such as in smartphones, tablet computers, PDAs and laptop computers, however this is not a requirement, and embodiments may be used in any system requiring power management of a processing unit.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims. The features of the claims may be combined in combinations other than those specified in the claims.

1. A method for power management for a processing unit, the processing unit configured to operate in a plurality of operating modes and further configured to provide information indicative of memory access miss events, the method comprising:
receiving said information indicative of memory access miss events;
determining a desired operating mode for the processing unit based at least on the received information; and
causing the processing unit to operate in the desired operating mode based on said determination.

2. The method of claim 1, wherein said causing step further comprises causing the processing unit to operate in a different one of the plurality of operating modes based on said determination.

3. The method of claim 1, wherein said determining step further comprises calculating a first value based on the received information indicative of memory access miss events and selecting said desired operating mode based on the first value.

4. The method of claim 3, wherein the information indicative of memory access miss events comprises a plurality of values, each representing a count for an associated memory access miss event in a given period of time.

5. The method of claim 4, further comprising calculating the first value based on a weighted average of the plurality of values.

6. The method of claim 5, wherein the weighting given to values associated with a level 2 memory access miss event is higher than the weighting given to values associated with a level 1 memory access miss event.

7. The method of claim 6, wherein the processing unit comprises a plurality of cores and is configured to provide information indicative of memory access miss events for each of the cores, the method further comprising:
determining, for each of the cores, the desired operating mode based on respective first values; and
causing the processing unit to operate in the desired operating mode.

8. The method of claim 7, wherein the processing unit is configured to provide further information indicative of memory access miss events for a memory shared between at least two of the cores, and the method further comprises:
determining a second value based on said further information; and
causing the processing unit to operate in the desired operating mode based on a combination of the selected one of the first values and the second value.

9. The method of claim 8, wherein the selected one of the first values is associated with the processing unit operating a mode providing the highest processing throughput.

10. The method claim 9, wherein each of the plurality of modes is associated with a different power consumption or processing throughput of the processing unit.

11. The method of claim 10, wherein each of the plurality of modes is associated with a different operating frequency or operating voltage for the processing unit.

12. The method claim 11, wherein the information indicative of memory access miss events comprises information indicative of level 1 memory access miss events.

13. The method of claim 12, wherein the information indicative of memory access miss events comprises information indicative of one or more of:
level 1 instruction cache misses;
level 1 data cache misses; and
level 1 translation lookaside buffer misses.

14. The method of claim 13, wherein the information indicative of memory access miss events comprises information indicative of level 2 memory access miss events.

15. The method of claim 14, wherein the information indicative of memory access miss events comprises information indicative of one or more of:
level 2 unified cache misses; and
main translation lookaside buffer misses.

16. The method of claim 15, wherein the operating mode is selected to be a relatively high power operating mode when the number of cache misses is relatively high, and the operating mode is selected to be a relatively low power operating mode when the number of cache misses is relatively low.

17. The method of claim 16, wherein the processing unit is further configured to provide information indicative of instructions executed by the processing unit, and the method further comprises:
receiving said information indicative of instructions executed by the processing unit; and
determining the desired operating mode based on both the received information indicative of memory access miss events and the received information indicative of instructions executed by the processing unit.

18. Apparatus for power management of a processing unit, the processing unit configured to operate in a plurality of operating modes and further configured to provide information indicative of memory access miss events, the apparatus comprising:
an interface configured to receive said information indicative of memory access miss events; and
a processor configured to determine a desired operating mode for the processing unit based at least on the received information,
wherein the apparatus is configured to cause the processing unit to operate in the desired operating mode based on said determination.

19. The apparatus of claim 18 comprising the said processing unit.

20. A computer program product comprising a non-transitory computer-readable storage medium having computer readable instructions stored thereon, the computer readable instructions being executable by a computerized device to cause the computerized device to perform a method for power management for a processing unit, the processing unit configured to operate in a plurality of operating modes and further configured to provide information indicative of memory access miss events, the method comprising:
receiving said information indicative of memory access miss events;
determining a desired operating mode for the processing unit based at least on the received information; and
causing the processing unit to operate in the desired operating mode based on said determination.
